(19) United States
(12) Patent Application Publication
(10) Pub. No.: US 2025/0168239 A1
(43) Pub. Date: May 22, 2025

(54) SERVICE RESPONSE METHOD AND APPARATUS, DEVICE, AND STORAGE MEDIUM

(71) Applicant: Beijing Bytedance Network Technology Co., Ltd., Beijing (CN)

(72) Inventors: Yuyao YANG, Beijing (CN); Jinyan WANG, Beijing (CN); Jianping CHEN, Beijing (CN)

(21) Appl. No.: 18/839,635

(22) PCT Filed: May 10, 2023
(86) PCT No.: PCT/CN2023/093269

§ 371 Date: Aug. 19, 2024

(30) Foreign Application Priority Data
May 11, 2022 (CN) 202210513481.0

(51) Int. Cl. H04L 67/146; H04L 67/141; H04L 69/16

(52) U.S. Cl. CPC H04L 67/146; H04L 67/141; H04L 69/162

(57) ABSTRACT

Embodiments of the present disclosure provide a service response method and apparatus, a device, and a storage medium. According to the method, a service request packet initiated by a request client through a preset service port is detected using a socket detection mechanism; target client identification information corresponding to the request client is determined based on the service request packet; then, based on the target client identification information, a target socket corresponding to the service request packet is determined from a pre-established service data file in which client identification information of connected clients and sockets of service response processes connected to the connected clients are correspondingly stored; and the service request packet is sent to a target service response process based on the target socket.

### CROSS-REFERENCE TO RELATED APPLICATION(S)

The present disclosure claims priority to Chinese Patent Application No. 202210513481.0, filed with the China National Intellectual Property Administration on May 11, 2022, which is incorporated herein by reference in its entirety.

### FIELD

Embodiments of the present disclosure relate to communication technologies, and for example, relate to a service response method and apparatus, a device, and a storage medium.

### BACKGROUND

In a server cluster, different servers may detect different ports. When requesting a service from a server, a client first performs port negotiation with the server, and then establishes an actual connection based on a negotiated port, that is, the client establishes a connection to the negotiated port.

However, in a scenario where the server cluster is controlled by load balancing scheduling, the above service request method may cause a server with which the client negotiates to be different from a server to which the client actually establishes a connection. For example, the client performs port negotiation with a server A, and a negotiated port is a port a, but due to load balancing scheduling, the client actually establishes a connection to a server B. Ports detected by servers may not be consistent. For example, the server B has not detected the port a, causing the client to fail in establishing a connection.

Therefore, the related art has the following technical problem: In the scenario of a server cluster with load balancing scheduling, the ports detected by the servers may be different, and if a server to which a client actually establishes a connection has not detected a port of a server that negotiates with the client, this causes a client service request to fail.

### SUMMARY

The present disclosure provides a service response method and apparatus, a device, and a storage medium, so as to solve the technical problem that in a scenario of a server cluster with load balancing scheduling, a client service request fails due to a server to which a client actually establishes a connection having not detected a port of a server that negotiates with the client.

According to a first aspect, an embodiment of the present disclosure provides a service response method, including:
in response to detecting, using a socket detection mechanism, a service request packet initiated by a request client through a preset service port, determining target client identification information corresponding to the request client based on the service request packet;
determining a target socket corresponding to the service request packet based on the target client identification information and a pre-established service data file, where client identification information of a connected client having connected to a service response process and a socket of the service response process connected to the connected client are stored in correspondence in the service data file; and
sending the service request packet to a target service response process through the target socket.

According to a second aspect, an embodiment of the present disclosure further provides a service response apparatus, including:
a client request module configured to, in response to detecting, using a socket detection mechanism, a service request packet initiated by a request client through a preset service port, determine target client identification information corresponding to the request client based on the service request packet;
a socket determination module configured to determine a target socket corresponding to the service request packet based on the target client identification information and a pre-established service data file, where the service data file is used to store a correspondence between client identification information of a connected client having connected to a service response process and a socket of the service response process connected to the connected client; and
a request response module configured to send the service request packet to a target service response process through the target socket.

According to a third aspect, an embodiment of the present disclosure further provides an electronic device. The electronic device includes:
at least one processor; and
a storage apparatus configured to store at least one program, where
the at least one program, when executed by the at least one processor, causes the at least one processor to implement the service response method described in any one of the embodiments of the present disclosure.

According to a fourth aspect, an embodiment of the present disclosure further provides a storage medium including computer executable instructions, where the computer executable instructions, when executed by a computer processor, are used to implement the service response method described in any one of the embodiments of the present disclosure.

### BRIEF DESCRIPTION OF THE DRAWINGS

Throughout the accompanying drawings, the same or similar reference numerals denote the same or similar elements. It should be understood that the accompanying drawings are schematic and that parts and elements are not necessarily drawn to scale.

FIG. 1 is a schematic flowchart of a service response method according to an embodiment of the present disclosure;

FIG. 2 is a schematic flowchart of another service response method according to an embodiment of the present disclosure;

FIG. 3A is a schematic flowchart of another service response method according to an embodiment of the present disclosure;

FIG. 3B is a schematic diagram of operation of an application layer NSS architecture according to an embodiment of the present disclosure;

FIG. 4A is a schematic flowchart of another service response method according to an embodiment of the present disclosure;

FIG. 4B is a schematic diagram of a process of a service response method according to an embodiment of the present disclosure;

FIG. 5 is a schematic diagram of a structure of a service response apparatus according to an embodiment of the present disclosure; and

FIG. 6 is a schematic diagram of a structure of an electronic device according to an embodiment of the present disclosure.

### DETAILED DESCRIPTION OF EMBODIMENTS

The embodiments of the present disclosure are described in more detail below with reference to the accompanying drawings.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”.

The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “at least one”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from a user, prompt information is sent to the user to clearly inform the user that a requested operation will require access to and use of personal information of the user. As such, the user can independently choose, based on the prompt information, whether to provide the personal information to software or hardware, such as an electronic device, an application, a server, or a storage medium, that performs the operations of the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It can be understood that the above process of notifying and obtaining user authorization is only illustrative and does not constitute a limitation on the implementations of the present disclosure, and other manners that satisfy the relevant laws and regulations may also be applied in the implementations of the present disclosure.

FIG. 1 is a schematic flowchart of a service response method according to an embodiment of the present disclosure. This embodiment of the present disclosure is applicable to a case of detecting a preset service port using a socket detection mechanism, obtaining a service request packet initiated by each client through a preset service port, determining a target service response process corresponding to the service request packet, and responding to the service request packet through the target service response process. The method may be performed by a service response apparatus. The apparatus may be implemented in the form of software and/or hardware, and is optionally implemented by an electronic device. The electronic device may be a mobile terminal, a personal computer (PC), a server, or the like.

As shown in FIG. 1, the method includes the following steps.

S110: When a service request packet initiated by a request client through a preset service port is detected using a socket detection mechanism, determine target client identification information corresponding to the request client based on the service request packet.

The socket detection mechanism may be a mechanism by which at least one socket corresponding to the preset service port in the server detects the preset service port, so as to detect the service request packet sent by each request client through the preset service port.

For example, the preset service port may be a port oriented to the request client to allow the request client to request a service from the server, and the request client may send the service request packet to the preset service port so as to request a service corresponding to the preset service port. Different services may correspond to different preset service ports. For example, a preset service port for requesting live streaming data is a port_a, and a preset service port for requesting web page update data is a port_b.

In this embodiment of the present disclosure, if the service request packet initiated by the request client through the preset service port is detected using the socket detection mechanism, identification information corresponding to the request client, namely, the target client identification information, may be determined based on the service request packet.

In an implementation, the service request packet may be parsed to obtain identification information that uniquely describes the request client from the service request packet, and the identification information is used as the target client identification information. For example, if the service request packet is a HyperText Transfer Protocol/3 (HTTP/3) packet, target client identification information that may be used to describe identity information of a request client may be directly extracted from the HTTP3 protocol packet.

In another optional implementation, target client identification information used to describe identity information of a request client may also be calculated based on information in the service request packet. For example, the service request packet carries a protocol port of a request client, an Internet protocol address of the request client, a protocol port of a service response process, an Internet protocol address of the service response process, and a transport layer protocol; and the determining target client identification information corresponding to the request client based on the service request packet includes: generating the target client identification information corresponding to the request client based on the protocol port of the request client, the Internet protocol address of the request client, the protocol port of the service response process, the Internet protocol address of the service response process, and the transport layer protocol.

The protocol port of the request client may be a source port of the service request packet; the Internet protocol address of the request client may be a source Internet protocol (IP) address of the service request packet; the protocol port of the service response process may be a destination port of the service request packet; and the Internet protocol address of the service response process may be a destination IP address of the service request packet.

In the optional implementation, the protocol port of the request client, the Internet protocol address of the request client, the protocol port of the service response process, the Internet protocol address of the service response process, and the transport layer protocol may be used as 5-tuple information of the service request packet, and the target client identification information corresponding to the request client is generated based on the 5-tuple information.

For example, for a service request packet of a real-time streaming via WebRTC (RTS) protocol, target client identification information may be generated based on 5-tuple information in the packet. In this way, the target unique identification information that describes the client requesting the service may be obtained, so that a process that responds to the client service request can be determined based on the unique identification information.

For example, the source port, the source IP, the destination port, the destination IP, and the transport layer protocol in the 5-tuple information may be directly combined, and a combined character string is used as the target client identification information corresponding to the request client. Alternatively, part of information from each of the source port, the source IP, the destination port, the destination IP, and the transport layer protocol may be selected and combined into the target client identification information corresponding to the request client.

For another example, the generating the target client identification information corresponding to the request client based on the protocol port of the request client, the Internet protocol address of the request client, the protocol port of the service response process, the Internet protocol address of the service response process, and the transport layer protocol may include: performing calculation by using a preset hash algorithm based on the protocol port of the request client, the Internet protocol address of the request client, the protocol port of the service response process, the Internet protocol address of the service response process, and the transport layer protocol, and using a calculated hash value as the target client identification information corresponding to the request client.

The preset hash algorithm may be a hash algorithm such as an MD5 message-digest algorithm (MD5) and a secure hash algorithm (SHA). The preset hash algorithm may be used to calculate a hash value, namely, a hash, which meets a preset length, based on the given 5-tuple information.

The hash value calculated by using the preset hash algorithm is unique, and different 5-tuple information corresponds to different hash values. Therefore, the target client identification information that meets a preset length can be obtained by performing calculation using the preset hash algorithm based on the 5-tuple information. Optionally, the preset length may be 32 bits, which is not limited in the embodiments of the present disclosure. Calculating the target client identification information using the hash algorithm can ensure that the target client identification information is unique. Moreover, the target client identification information of the fixed length can be obtained, thereby reducing the storage overheads required for the target client identification information.

S120: Determine a target socket corresponding to the service request packet based on the target client identification information and a pre-established service data file, where client identification information of a connected client having connected to a service response process and a socket of the service response process connected to the connected client are stored in correspondence in the service data file.

The service data file records the client identification information of the connected client having connected to the service response process and the socket of the service response process connected to the connected client. The service response process may be a process in the server that is used to respond to a service of a client, namely, a process for processing a service request packet from the client. For each service response process, a corresponding socket may be set.

For example, after the target client identification information is obtained, it may be queried whether the target client identification information exists in the service data file. If yes, it indicates that the request client is a connected client that has connected to the service response process. A socket corresponding to the target client identification information in the service data file may be used as the target socket corresponding to the service request packet, such that the service request packet is processed by using a service response process connected to the request client last time.

If the target client identification information does not exist in the service data file, it may indicate that the request client is an unconnected client that has not been connected to the service response process. For the unconnected client, according to a protocol corresponding to the service request packet, a target socket that is in accordance with the protocol corresponding to the service request packet may be determined from at least one socket for monitoring the preset service port.

Alternatively, if the target client identification information does not exist in the service data file, estimated processing overheads corresponding to the service request packet may further be determined, and the target socket is determined from the at least one socket based on the estimated processing overheads and load information of a service response process corresponding to at least one socket for monitoring the preset service port. For example, according to the principle of load balancing scheduling for service response processes in the server, a target service response process is determined from the service response processes by using the load information of the service response process corresponding to the at least one socket and the estimated processing overheads for processing the service request packet. A socket corresponding to the target service response process is used as the target socket.

Alternatively, if the target client identification information does not exist in the service data file, the target service response process may be determined from the service response processes based on priorities of the service response processes corresponding to the sockets and the load information of the service response processes. A socket corresponding to the target service response process is used as the target socket.

S130: Send the service request packet to the target service response process through the target socket.

For example, after the target socket corresponding to the service request packet is determined, the service request packet may be sent to the target service response process corresponding to the target socket through the target socket, such that the target service response process processes the service request packet, that is, responds to the service request of the client.

In the technical solution of this embodiment of the present disclosure, the service request packet initiated by the request client through the preset service port is detected using the socket detection mechanism; the target client identification information corresponding to the request client is determined based on the service request packet; then, based on the target client identification information, the target socket corresponding to the service request packet is determined from the pre-established service data file that stores the client identification information of the connected client and the socket of the service response process connected to the connected client in correspondence; and the service request packet is sent to the target service response process based on the target socket. After the service request is obtained by detecting the preset service port, the corresponding socket is selected based on the target client identification information, and then, the process for processing the service request packet is selected through the socket. In this way, the process that responds to the service request is accurately determined, thereby responding to the service request of the client based on detection of the preset service port, solving the technical problem that in a scenario of a server cluster with load balancing scheduling, a client service request fails due to a server to which a client actually establishes a connection having not detected a port of a server that negotiates with the client, and ensuring an effective response to the client service request in the scenario of the server cluster with load balancing scheduling. In addition, the method is independent of the server cluster with load balancing scheduling, and is also applicable to various servers, with strong scalability and portability.

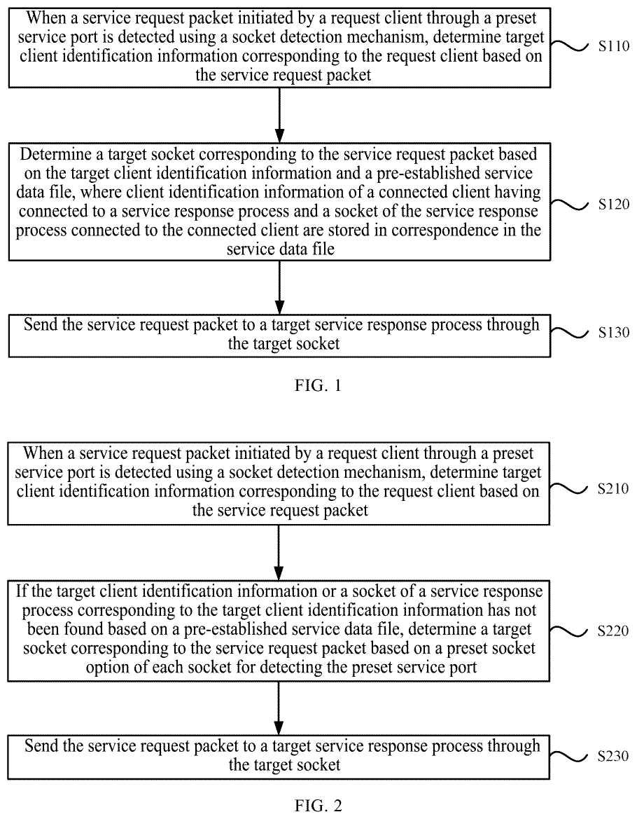

FIG. 2 is a schematic flowchart of another service response method according to an embodiment of the present disclosure. Optionally, determining a target socket corresponding to a service request packet based on target client identification information and a pre-established service data file includes: if the target client identification information or a socket of a service response process corresponding to the target client identification information has not been found based on the pre-established service data file, determining the target socket corresponding to the service request packet based on a preset socket option of at least one socket for detecting a preset service port. As shown in FIG. 2, the method includes the following steps.

S210: When a service request packet initiated by a request client through a preset service port is detected using a socket detection mechanism, determine target client identification information corresponding to the request client based on the service request packet.

S220: If the target client identification information or a socket of a service response process corresponding to the target client identification information has not been found based on a pre-established service data file, determine a target socket corresponding to the service request packet based on a preset socket option of at least one socket for detecting a preset service port.

The preset socket option may include at least one of attribute information such as a service protocol, a process category, a process priority, and a load of a socket. In this embodiment, each socket has a corresponding preset socket option. In a process of determining the target socket corresponding to the service request packet, the target socket may be selected based on the preset socket option of the at least one socket for detecting the preset service port.

For example, if the target client identification information or a socket of a service response process corresponding to the target client identification information has not been found in the service data file, it may be determined that the request client is a client that is connected for the first time. For the client that is connected for the first time, for example, the determining a target socket corresponding to the service request packet based on a preset socket option of at least one socket for detecting a preset service port may include: determining, based on load information and a process priority of the preset socket option of the at least one socket for detecting the preset service port, the target socket from the at least one socket for detecting the preset service port.

In an optional implementation, the preset socket option includes a process flag, and the process flag is used to reflect a correspondence between a socket and a service response process. The determining a target socket corresponding to the service request packet based on a preset socket option of at least one socket for detecting a preset service port includes: determining the target socket corresponding to the service request packet based on a process flag of the at least one socket for detecting the preset service port.

The process flag may be used to determine a process category of the service response process corresponding to the socket. For example, in a scenario of real time streaming via WebRTC (RTS) smooth upgrade of the server, the service response process may include an old service response process for connecting to a service resource before a service version update and a new service response process for connecting to a service resource after the service version update. That is, the process flag may be used to distinguish whether the service response process corresponding to the socket is the old service response process or the new service response process.

Typically, the solution of this embodiment of the present disclosure may be applied to the smooth upgrade scenario. Smooth upgrade refers to a hot update of the server version without stopping a service. In the update process, the existing connection remains uninterrupted, and normal services can be provided to the outside. The service request of the client may be separately processed by the old service response process and the new service response process.

For example, when the target client identification information or a socket of a service response process corresponding to the target client identification information has not been found in the service data file, based on a process flag of at least one socket for detecting a preset service port, a socket corresponding to the new service response process is determined from the at least one socket, and the socket corresponding to the new service response process is used as a target socket, such that the service request packet is sent to the new service response process through the target socket for processing. In the optional implementation, the process responding to the service request packet is determined based on the process flag of the socket, thereby accurately determining the process responding to the service request packet, and ensuring the responding to the client service request.

Optionally, the determining the target socket corresponding to the service request packet based on a process flag of the at least one socket for detecting the preset service port may include: determining, based on the process flag of the at least one socket for detecting the preset service port, a socket corresponding to the new service response process as a candidate socket; and determining the target socket corresponding to the service request packet based on the candidate socket.

For example, a process flag being 1 indicates that a service response process corresponding to a socket with the process flag is an old service response process, and a process flag being 0 indicates that a service response process corresponding to a socket with the process flag is a new service response process.

For example, based on a value of the process flag, the socket corresponding to the new service response process may be determined as the candidate socket from all sockets for detecting the preset service port. The target socket is determined from the candidate socket based on a load, a priority, or a service protocol of the candidate socket. In this way, the old service response process or the new service response process responding to the service request packet of the client is determined, and in the scenario of the RTS smooth upgrade of the server, when the client makes a first request to the server, the request is processed by the process connected to the service resource after the service version update, and when a request made to the server is not the first request, the request is processed by the process connected to the service resource before the service version update, thereby ensuring the effective response to the service request of the client with the RTS smooth upgrade of the server.

S230: Send the service request packet to the target service response process through the target socket.

Optionally, after the service request packet is sent to the target service response process through the target socket, the method further includes: storing the target client identification information corresponding to the request client and the target socket in correspondence in the service data file.

That is, after the service request packet of the request client is processed, the request client may be considered as a connected client having connected to the service response process. Therefore, the target client identification information corresponding to the request client and the target socket may be stored to the service data file in association with each other, such that when the service request packet of the request client is subsequently obtained, the target socket may be determined based on the target client identification information stored in the service data file that corresponds to the request client.

In the above method, a description is provided for the case where the target client identification information or a socket of a service response process corresponding to the target client identification information has not been found in the service data file. Optionally, the method further includes: if a socket of a service response process corresponding to the target client identification information is found based on the pre-established service data file, using the found socket of the service response process corresponding to the target client identification information as the target socket corresponding to the service request packet.

That is, if the socket of the service response process corresponding to the target client identification information is found in the service data file, it is determined that the request client is not a client that is connected for the first time. On this basis, the found socket of the service response process corresponding to the target client identification information may be used as the target socket, so as to continue processing the service request packet of the request client through the service response process corresponding to the target socket. In this way, the service response to the client with a service request being responded to may continue through a process historically responding to the service request of the client.

In the technical solution of this embodiment of the present disclosure, when the target client identification information or the socket of the service response process corresponding to the target client identification information has not been found in the pre-established service data file, the target socket corresponding to the service request packet is determined based on the preset socket option of the at least one socket for detecting the preset service port, thereby accurately determining the process responding to the service request of the client for the first time, and ensuring the effective response to the service request of the client.

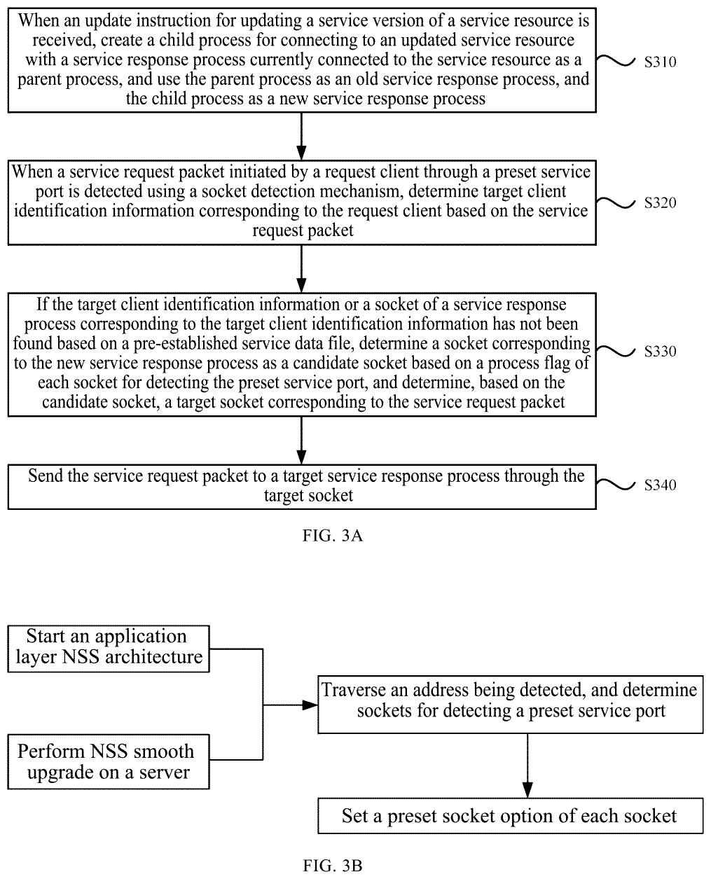

FIG. 3A is a schematic flowchart of another service response method according to an embodiment of the present disclosure. Optionally, the method further includes: when an update instruction for updating a service version of a service resource is received, creating a child process for connecting to an updated service resource with a service response process currently connected to the service resource as a parent process, and using the parent process as an old service response process, and the child process as a new service response process. As shown in FIG. 3A, the method includes the following steps.

S310: When an update instruction for updating a service version of a service resource is received, create a child process for connecting to an updated service resource with a service response process currently connected to the service resource as a parent process, and use the parent process as an old service response process, and the child process as a new service response process.

The update instruction may be sent by the cloud or a management server. For example, when detecting there is a new version, the cloud or the management server generates an update instruction and sends the update instruction to the server. Alternatively, the update instruction may be automatically generated when a user triggers a version update control.

For example, if the server receives the update instruction, it indicates that the server needs to update the service version so as to update the service resource oriented to the client; and in this case, the service response process currently connected to the service resource may be used as the parent process, namely, the old service response process, and the child process for connecting to the updated service resource, namely, the new service response process, is created. The child process may inherit information such as a data segment, a user stack, an address space, and a shared memory of the parent process.

In this embodiment, if the server creates a new service response process, in order to distinguish between the new service response process and the old service response process, preset socket options may be added to sockets corresponding to the service response processes when the new service response process is created.

That is, optionally, the method further includes: adding a preset socket option to at least one socket corresponding to the old service response process and used to detect the preset service port, so as to distinguish a correspondence between the at least one socket and each of the old service response process and the new service response process and/or a correspondence between the at least one socket and a packet type of the service request packet.

For example, when the new service response process is created, preset socket options may be added to a socket corresponding to the old service response process and a socket corresponding to the new service response process. If the preset socket option includes a process flag, whether the service response process corresponding to each socket is the old service response process or the new service response process may be distinguished. If the preset socket option includes a protocol flag, a service protocol corresponding to each socket may be distinguished, that is, the packet type of the service request packet that can be processed by using the socket may be distinguished.

By adding the preset socket option to the at least one socket corresponding to the old service response process and used to detect the preset service port, the correspondence between the at least one socket and each of the old service response process and the new service response process may be distinguished. In addition, the correspondence between the socket and the packet type of the service request packet may be distinguished. Therefore, when the service request packet is obtained, the corresponding target socket is determined based on the preset socket option.

Optionally, an application layer next generation streaming server (NSS) architecture may be deployed in the server, and the corresponding preset socket option is set, through the application layer NSS architecture, for the at least one socket for detecting the preset service port. For example, FIG. 3B is a schematic diagram of operation of an application layer NSS architecture. First, the application layer NSS architecture is activated, and NSS smooth upgrade is performed on the server; and the NSS architecture is initialized, traverses an address being detected, determines at least one socket for detecting a preset service port, assigns a preset mark to a process flag in a preset socket option of a socket corresponding to the parent process, or assigns a value to a protocol flag in the preset socket option of the at least one socket based on a service protocol of the at least one socket, in order to set the preset socket option of the at least one socket.

S320: When a service request packet initiated by a request client through the preset service port is detected using a socket detection mechanism, determine target client identification information corresponding to the request client based on the service request packet.

S330: If the target client identification information or a socket of a service response process corresponding to the target client identification information has not been found based on a pre-established service data file, determine a socket corresponding to the new service response process as a candidate socket based on a process flag of at least one socket for detecting the preset service port, and determine, based on the candidate socket, a target socket corresponding to the service request packet.

In this embodiment, any candidate socket may be used as the target socket. Alternatively, the target socket corresponding to the service request packet may be determined from the candidate sockets based on a preset polling mechanism. For example, in the preset polling mechanism, the target socket corresponding to the current service request packet may be sequentially determined according to an order in a preset arrangement list of sockets corresponding to various new service response processes.

S340: Send the service request packet to the target service response process through the target socket.

For example, in the scenario of smooth upgrade of the server, the process for processing the service request packet sent by the current request client may be determined through the above method. Smooth upgrade refers to a hot update of the server version without stopping a service. In the update process, the existing connection remains uninterrupted, and normal services can be provided to the outside. Smooth upgrade generally refers to a method in which the server starts a child process in the parent process and shuts down the parent process after a period of time, where the child process represents a new version. The smooth upgrade of the RTS protocol currently uses a dual-port mode, that is, the child process and the parent process detect different ports respectively. During RTS handshaking, the client may first perform port negotiation with the server. If the server is in a smooth upgrade period, a negotiation result is a child process port, such that the client establishes a connection to the child process port. However, under load balancing scheduling of the server cluster, a server with which the client negotiates may differ from a server to which the client actually establishes a connection, and ports detected by servers may also be different, which may cause the client to fail in establishing a connection, and cause a service request of the RTS protocol of the client to fail. Therefore, to solve the problem, the service response method provided in embodiments of the present disclosure may be used to detect the preset service port and obtain the service request packet of the RTS protocol sent by the client. After each server obtains the service request packet of the client by detecting the preset service port, the target client identification information is determined. If there is no socket corresponding to the target client identification information in the service data file, the socket corresponding to the new service response process may be determined through the process flag of the at least one socket, such that the service request packet is handed over to the new service response process for processing, thereby determining the process for processing the service request packet, then responding to the service request of the client, and solving the problem that the service request of the smooth grade of the RTS protocol of the client fails due to detection of different ports by the servers in the server cluster.

In the technical solution of this embodiment of the present disclosure, when the update instruction for updating the service version of the service resource is received, the service response process currently connected to the service resource is used as the parent process, namely, the old service response process, and the child process for connecting to the updated service resource, namely, the new service response process, is created, thereby determining the new service response process and the old service response process. In the scenario of the RTS smooth upgrade of the server, responses may be respectively made through the new service response process and the old service response process to a client requesting a service for the first time and a client requesting a service not for the first time.

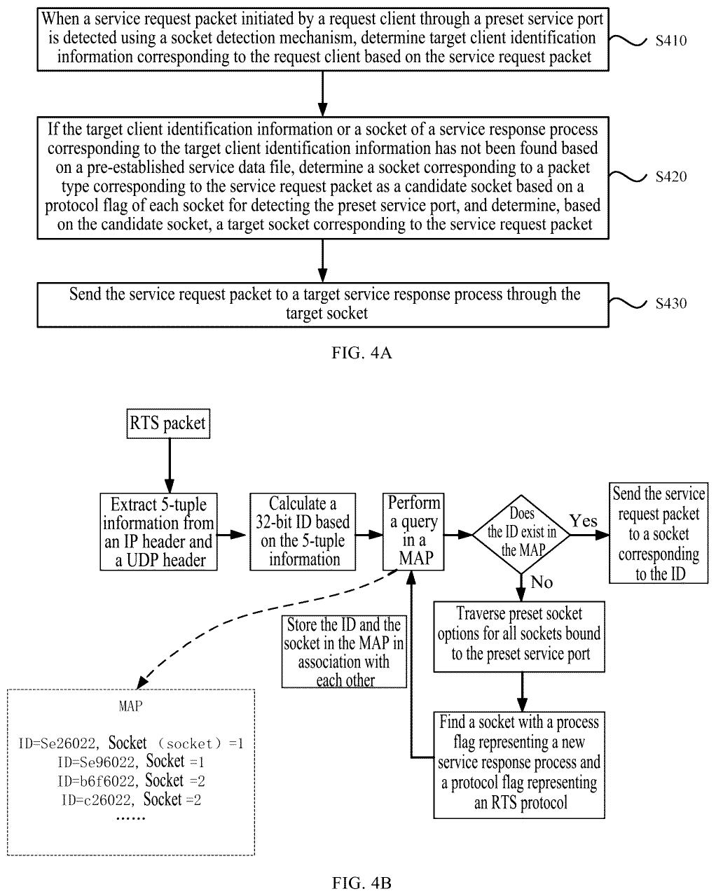

FIG. 4A is a schematic flowchart of another service response method according to an embodiment of the present disclosure. Optionally, in the method, the preset socket option further includes a protocol flag, and the protocol flag is used to reflect a correspondence between a socket and a packet type of a service request packet; and the determining a target socket corresponding to a service request packet based on a preset socket option of at least one socket for detecting a preset service port includes: determining a socket corresponding to the packet type corresponding to the service request packet as a candidate socket based on the protocol flag of the at least one socket for detecting the preset service port; and determining the target socket corresponding to the service request packet based on the candidate socket. As shown in FIG. 4A, the method includes the following steps.

S410: When a service request packet initiated by a request client through the preset service port is detected using a socket detection mechanism, determine target client identification information corresponding to the request client based on the service request packet.

S420: If the target client identification information or a socket of a service response process corresponding to the target client identification information has not been found based on a pre-established service data file, determine a socket corresponding to a packet type corresponding to the service request packet as a candidate socket based on a protocol flag of at least one socket for detecting the preset service port, and determine, based on the candidate socket, a target socket corresponding to the service request packet.

The protocol flag may be a flag used to describe a service protocol of the socket. For example, if the service protocol of the socket is the RTS protocol, the protocol flag may be 1, if the service protocol of the socket is the HTTP/3 protocol, the protocol flag may be 2, and so on.

For example, in this embodiment, when the target client identification information or the socket of the service response process corresponding to the target client identification information has not been found based on the service data file, the socket corresponding to the packet type of the service request packet is determined from the at least one socket as the candidate socket based on the protocol flag of the at least one socket for detecting the preset service port, that is, the socket with the service protocol consistent with the packet type is determined as the candidate socket.

For example, any one of candidate sockets may be used as the target socket. Alternatively, the target socket is determined from the candidate sockets based on load information of the candidate sockets.

Optionally, the determining, based on a candidate socket, a target socket corresponding to the service request packet may further include: determining the target socket corresponding to the service request packet based on the process flag of the candidate socket. For example, the candidate socket corresponding to the new service response process may be determined as the target socket based on the process flag of the candidate socket. It can be understood that if there are a plurality of candidate sockets corresponding to the new service response process, any one of the candidate sockets may be used as the target socket, or a candidate socket with a minimum load may be used as the target socket.

In this manner, when the target client identification information or the socket of the service response process corresponding to the target client identification information has not been found based on the pre-established service data file, that is, the request client is a client requesting a service for the first time, the socket corresponding to the new service response process that satisfies the packet type of the service request packet is determined from the at least one socket based on the process flag and the protocol flag of the at least one socket for detecting the preset service port, thereby accurately determining the socket based on the process flag and the protocol flag.

For example, FIG. 4B is a schematic diagram of a process of a service response method. For example, the service request packet is an RTS packet. First, 5-tuple information may be extracted from an IP header and a user datagram protocol (UDP) header of the RTS packet, and then a 32-bit ID (i.e., the target client identification information) is calculated based on the 5-tuple information. Based on the target client identification information, a query is performed in a MAP (i.e., the service data file) to check whether the ID exists in the MAP. When the ID exists in the MAP, the service request packet is sent to a socket (i.e., the target socket) corresponding to the ID. When the ID does not exist in the MAP, preset socket options for all sockets bound to the preset service port are traversed to find a socket with the process flag representing the new service response process and the protocol flag representing the RTS protocol, the service request packet is sent to the socket, and the ID and the socket are stored in the MAP in association with each other.

S430: Send the service request packet to a target service response process through the target socket.

In the technical solution of this embodiment of the present disclosure, when the target client identification information or the socket of the service response process corresponding to the target client identification information has not been found based on the pre-established service data file, the socket corresponding to the packet type corresponding to the service request packet is determined as the candidate socket based on the protocol flag of the at least one socket for detecting the preset service port, and the target socket corresponding to the service request packet is determined based on the candidate socket, thereby accurately determining, based on the process flag, the process responding to the service request of the client for the first time, and ensuring the effective response to the service request of the client.

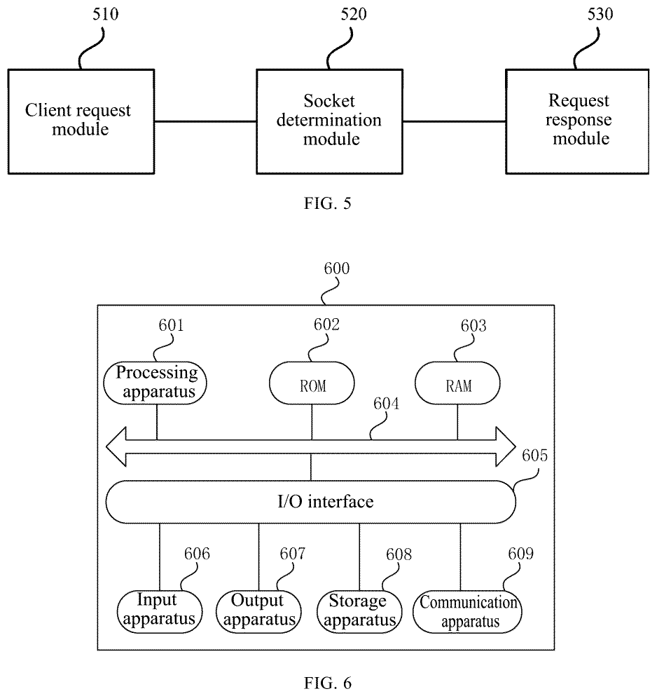

FIG. 5 is a schematic diagram of a structure of a service response apparatus according to an embodiment of the present disclosure. As shown in FIG. 5, the apparatus includes: a client request module 510, a socket determination module 520, and a request response module 530.

The client request module 510 is configured to, when a service request packet initiated by a request client through a preset service port is detected using a socket detection mechanism, determine target client identification information corresponding to the request client based on the service request packet;
the socket determination module 520 is configured to determine a target socket corresponding to the service request packet based on the target client identification information and a pre-established service data file, where the service data file is used to store a correspondence between client identification information of a connected client having connected to a service response process and a socket of the service response process connected to the connected client; and
the request response module 530 is configured to send the service request packet to a target service response process through the target socket.

Optionally, this embodiment may further provide a kernel module. The service response apparatus is integrated in the kernel module. The kernel module may hand over the service request packet sent by the client to a correct service response process for processing through the service response apparatus.

In the technical solution provided in this embodiment of the present disclosure, the service request packet initiated by the request client through the preset service port is detected using the socket detection mechanism; the target client identification information corresponding to the request client is determined based on the service request packet; then, based on the target client identification information, the target socket corresponding to the service request packet is determined from the pre-established service data file that stores the client identification information of the connected client and the socket of the service response process connected to the connected client in correspondence; and the service request packet is sent to the target service response process based on the target socket. After the service request is obtained by detecting the preset service port, the corresponding socket is selected based on the target client identification information, and then, the process for processing the service request packet is selected through the socket. In this way, the process that responds to the service request is accurately determined, thereby responding to the service request of the client based on detection of the preset service port, solving the technical problem that in a scenario of a server cluster with load balancing scheduling, a client service request fails due to a server to which a client actually establishes a connection having not detected a port of a server that negotiates with the client, and ensuring an effective response to the client service request in the scenario of the server cluster with load balancing scheduling. In addition, the method is independent of the server cluster with load balancing scheduling, and is also applicable to various servers, with strong scalability and portability.

On the basis of any one of the optional technical solutions of the embodiments of the present disclosure, optionally, the service request packet carries a protocol port of a request client, an Internet protocol address of the request client, a protocol port of a service response process, an Internet protocol address of the service response process, and a transport layer protocol; and The client request module 510 includes an identification determination unit. The identification determination unit is configured to generate the target client identification information corresponding to the request client based on the protocol port of the request client, the Internet protocol address of the request client, the protocol port of the service response process, the Internet protocol address of the service response process, and the transport layer protocol.

On the basis of any one of the optional technical solutions of the embodiments of the present disclosure, optionally, the identification determination unit is configured to: perform calculation by using a preset hash algorithm based on the protocol port of the request client, the Internet protocol address of the request client, the protocol port of the service response process, the Internet protocol address of the service response process, and the transport layer protocol, and use a calculated hash value as the target client identification information corresponding to the request client.

On the basis of any one of the optional technical solutions of the embodiments of the present disclosure, optionally, the socket determination module 520 includes a first socket determination unit. The first socket determination unit is configured to: if the target client identification information or a socket of a service response process corresponding to the target client identification information has not been found based on a pre-established service data file, determine the target socket corresponding to the service request packet based on a preset socket option of at least one socket for detecting the preset service port.

On the basis of any one of the optional technical solutions of the embodiments of the present disclosure, optionally, the preset socket option includes a process flag, and the process flag is used to reflect a correspondence between a socket and a service response process; and the first socket determination unit is further configured to determine the target socket corresponding to the service request packet based on a process flag of the at least one socket for detecting the preset service port.

On the basis of any one of the optional technical solutions of the embodiments of the present disclosure, optionally, the service response process includes an old service response process for connecting to a service resource before a service version update and a new service response process for connecting to a service resource after the service version update; and the first socket determination unit is further configured to determine, based on the process flag of the at least one socket for detecting the preset service port, a socket corresponding to the new service response process as a candidate socket; and determine the target socket corresponding to the service request packet based on the candidate socket.

On the basis of any one of the optional technical solutions of the embodiments of the present disclosure, optionally, the apparatus further includes a process creation module. The process creation module is configured to, when an update instruction for updating a service version of a service resource is received, create a child process for connecting to an updated service resource with a service response process currently connected to the service resource as a parent process, and use the parent process as an old service response process, and the child process as a new service response process.

On the basis of any one of the optional technical solutions of the embodiments of the present disclosure, optionally, the process creation module is further configured to add a preset socket option to at least one socket corresponding to the old service response process and used to detect the preset service port, so as to distinguish a correspondence between the at least one socket and each of the old service response process and the new service response process and/or a correspondence between the at least one socket and a packet type of the service request packet.

On the basis of any one of the optional technical solutions of the embodiments of the present disclosure, optionally, the preset socket option further includes a protocol flag, and the protocol flag is used to reflect a correspondence between a socket and a packet type of the service request packet; and the socket determination module 520 includes a second socket determination unit, and the second determination unit is configured to determine a socket corresponding to the packet type corresponding to the service request packet as a candidate socket based on the protocol flag of the at least one socket for detecting the preset service port; and determine the target socket corresponding to the service request packet based on the candidate socket.

On the basis of any one of the optional technical solutions of the embodiments of the present disclosure, optionally, the socket determination module is further configured to store the target client identification information corresponding to the request client and the target socket in correspondence in the service data file.

On the basis of any one of the optional technical solutions of the embodiments of the present disclosure, optionally, the socket determination module is further configured to: if a socket of a service response process corresponding to the target client identification information is found based on the pre-established service data file, using the found socket of the service response process corresponding to the target client identification information as the target socket corresponding to the service request packet.

The service response apparatus provided in this embodiment of the present disclosure may perform the service response method provided in any embodiment of the present disclosure, and has corresponding function modules for performing the method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the protection scope of the embodiments of the present disclosure.

FIG. 6 is a schematic diagram of a structure of an electronic device according to an embodiment of the present disclosure. Reference is made to FIG. 6 below, which is a schematic diagram of a structure of an electronic device (such as a terminal device or a server in FIG. 6) 600 suitable for implementing an embodiment of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital television (TV) and a desktop computer. The electronic device shown in FIG. 6 is merely an example, and shall not impose any limitation on the function and scope of use of the embodiments of the present disclosure.

As shown in FIG. 6, the electronic device 600 may include a processing apparatus (e.g., a central processing unit, a graphics processing unit, etc.) 601 that may perform a variety of appropriate actions and processing in accordance with a program stored in a read-only memory (ROM) 602 or a program loaded from a storage apparatus 608 into a random access memory (RAM) 603. The RAM 603 further stores various programs and data required for the operation of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 including, for example, a touch screen, a touchpad, a keyboard, a mouse, a camera, a microphone, an accelerometer, and a gyroscope; an output apparatus 607 including, for example, a liquid crystal display (LCD), a speaker, and a vibrator; the storage apparatus 608 including, for example, a tape and a hard disk; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 609, installed from the storage apparatus 608, or installed from the ROM 602. When the computer program is executed by the processing apparatus 601, the above-mentioned functions defined in the method of the embodiment of the present disclosure are performed.

The names of messages or information exchanged between a plurality of apparatuses in the implementations of the present disclosure are used for illustrative purposes only, and are not used to limit the scope of these messages or information.

The electronic device provided in this embodiment of the present disclosure and the service response method provided in the above embodiment belong to the same inventive concept. For the technical details not described in detail in this embodiment, reference may be made to the above embodiment.

An embodiment of the present disclosure provides a computer storage medium storing a computer program thereon, where the program, when executed by a processor, implements the service response method provided in the above embodiment.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, where the data signal carries computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with the instruction execution system, apparatus, or device. The program code contained in the computer-readable medium may be transmitted by any suitable medium, including but not limited to: an electric wire, an optical cable, radio frequency (RF), etc., or any suitable combination thereof.

In some implementations, a client and a server may communicate using any currently known or future-developed network protocol such as the HyperText Transfer Protocol (HTTP), and may be connected to digital data communication (for example, a communication network) in any form or medium. Examples of the communication network include a local area network (LAN), a wide area network (WAN), an internetwork (e.g., the Internet), a peer-to-peer network (e.g., an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries at least one program, and the at least one program, when executed by the electronic device, causes the electronic device to:

The above computer-readable medium carries at least one program, and the at least one program, when executed by the electronic device, causes the electronic device to: when a service request packet initiated by a request client through the preset service port is detected using a socket detection mechanism, determine target client identification information corresponding to the request client based on the service request packet; determine a target socket corresponding to the service request packet based on the target client identification information and a pre-established service data file, where client identification information of a connected client having connected to a service response process and a socket of the service response process connected to the connected client are stored in correspondence in the service data file; and send the service request packet to a target service response process through the target socket.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving a remote computer, the remote computer may be connected to a computer of a user over any type of network, including a local area network (LAN) or a wide area network (WAN), or may be connected to an external computer (for example, connected over the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession may actually be performed substantially in parallel, or may sometimes be performed in a reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software or hardware. Names of the units do not constitute a limitation on the units themselves in some cases, for example, a first obtaining unit may alternatively be described as “a unit for obtaining at least two Internet Protocol addresses”.

The functions described herein above may be performed at least partially by one or more hardware logic components. For example, without limitation, exemplary types of hardware logic components that may be used include: a field programmable gate array (FPGA), an application specific integrated circuit (ASIC), application specific standard parts (ASSPs), a system on chip (SOC), a complex programmable logic device (CPLD), etc.

In the context of the present disclosure, a machine-readable medium may be a tangible medium that may include or store a program used by or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

According to at least one embodiment of the present disclosure, [Example 1] provides a service response method, including:
when a service request packet initiated by a request client through the preset service port is detected using a socket detection mechanism, determining target client identification information corresponding to the request client based on the service request packet;
determining a target socket corresponding to the service request packet based on the target client identification information and a pre-established service data file, where client identification information of a connected client having connected to a service response process and a socket of the service response process connected to the connected client are stored in correspondence in the service data file; and
sending the service request packet to a target service response process through the target socket.

According to at least one embodiment of the present disclosure, [Example 2] provides a service response method, and the method further includes:

Optionally, the service request packet carries a protocol port of a request client, an Internet protocol address of the request client, a protocol port of a service response process, an Internet protocol address of the service response process, and a transport layer protocol; and
the determining target client identification information corresponding to the request client based on the service request packet includes:
generating the target client identification information corresponding to the request client based on the protocol port of the request client, the Internet protocol address of the request client, the protocol port of the service response process, the Internet protocol address of the service response process, and the transport layer protocol.

According to at least one embodiment of the present disclosure, [Example 3] provides a service response method, and the method further includes:

Optionally, the generating the target client identification information corresponding to the request client based on the protocol port of the request client, the Internet protocol address of the request client, the protocol port of the service response process, the Internet protocol address of the service response process, and the transport layer protocol includes:
performing calculation by using a preset hash algorithm based on the protocol port of the request client, the Internet protocol address of the request client, the protocol port of the service response process, the Internet protocol address of the service response process, and the transport layer protocol, and using a calculated hash value as the target client identification information corresponding to the request client.

According to at least one embodiment of the present disclosure, [Example 4] provides a service response method, and the method further includes:

Optionally, the determining a target socket corresponding to the service request packet based on the target client identification information and a pre-established service data file includes:
if the target client identification information or a socket of a service response process corresponding to the target client identification information has not been found based on the pre-established service data file, determining the target socket corresponding to the service request packet based on a preset socket option of at least one socket for detecting a preset service port.

According to at least one embodiment of the present disclosure, [Example 5] provides a service response method, and the method further includes:

Optionally, the preset socket option includes a process flag, and the process flag is used to reflect a correspondence between a socket and a service response process; and
the determining the target socket corresponding to the service request packet based on a preset socket option of at least one socket for detecting the preset service port includes:
determining the target socket corresponding to the service request packet based on a process flag of the at least one socket for detecting the preset service port.

According to at least one embodiment of the present disclosure, [Example 6] provides a service response method, and the method further includes:

Optionally, the service response process includes an old service response process for connecting to a service resource before a service version update and a new service response process for connecting to a service resource after the service version update; and
the determining the target socket corresponding to the service request packet based on a process flag of the at least one socket for detecting the preset service port includes:
determining, based on the process flag of the at least one socket for detecting the preset service port, a socket corresponding to the new service response process as a candidate socket; and
determining the target socket corresponding to the service request packet based on the candidate socket.

According to at least one embodiment of the present disclosure, [Example 7] provides a service response method, and the method further includes:

Optionally, the method further includes:
when an update instruction for updating a service version of a service resource is received, creating a child process for connecting to an updated service resource with a service response process currently connected to the service resource as a parent process, and using the parent process as an old service response process, and the child process as a new service response process.

According to at least one embodiment of the present disclosure, [Example 8] provides a service response method, and the method further includes:

Optionally, the method further includes:
adding a preset socket option to at least one socket corresponding to the old service response process and used to detect the preset service port, so as to distinguish a correspondence between the at least one socket and each of the old service response process and the new service response process and/or a correspondence between the at least one socket and a packet type of the service request packet.

According to at least one embodiment of the present disclosure, [Example 9] provides a service response method, and the method further includes:
Optionally, the preset socket option further includes a protocol flag, and the protocol flag is used to reflect a correspondence between a socket and a packet type of the service request packet; and
the determining the target socket corresponding to the service request packet based on a preset socket option of at least one socket for detecting the preset service port includes:
determining a socket corresponding to the packet type corresponding to the service request packet as a candidate socket based on the protocol flag of the at least one socket for detecting the preset service port; and
determining the target socket corresponding to the service request packet based on the candidate socket.

According to at least one embodiment of the present disclosure, [Example 10] provides a service response method, and the method further includes:

Optionally, after the sending the service request packet to a target service response process through the target socket, the method further includes:
storing the target client identification information corresponding to the request client and the target socket in correspondence in the service data file.

According to at least one embodiment of the present disclosure, [Example 11] provides a service response method, and the method further includes:

Optionally, the method further includes:
if a socket of a service response process corresponding to the target client identification information is found based on the pre-established service data file, using the found socket of the service response process corresponding to the target client identification information as the target socket corresponding to the service request packet.

According to at least one embodiment of the present disclosure, [Example 12] provides a service response apparatus, and the apparatus includes:
a client request module configured to, when a service request packet initiated by a request client through the preset service port is detected using a socket detection mechanism, determine target client identification information corresponding to the request client based on the service request packet;
a socket determination module configured to determine a target socket corresponding to the service request packet based on the target client identification information and a pre-established service data file, where the service data file is used to store a correspondence between client identification information of a connected client having connected to a service response process and a socket of the service response process connected to the connected client; and
a request response module configured to send the service request packet to a target service response process through the target socket.

In addition, although the various operations are depicted in a specific order, it should not be understood as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

1-14. (canceled)

15. A service response method, comprising:
in response to detecting, using a socket detection mechanism, a service request packet initiated by a request client through a preset service port, determining target client identification information corresponding to the request client based on the service request packet;
determining a target socket corresponding to the service request packet based on the target client identification information and a pre-established service data file, wherein client identification information of a connected client having connected to a service response process and a socket of the service response process connected to the connected client are stored in correspondence in the service data file; and
sending the service request packet to a target service response process through the target socket.

16. The service response method according to claim 15, wherein the service request packet carries a protocol port of a request client, an Internet protocol address of the request client, a protocol port of a service response process, an Internet protocol address of the service response process, and a transport layer protocol; and
the determining target client identification information corresponding to the request client based on the service request packet comprises:
generating the target client identification information corresponding to the request client based on the protocol port of the request client, the Internet protocol address of the request client, the protocol port of the service response process, the Internet protocol address of the service response process, and the transport layer protocol.

17. The service response method according to claim 16, wherein the generating the target client identification information corresponding to the request client based on the protocol port of the request client, the Internet protocol address of the request client, the protocol port of the service response process, the Internet protocol address of the service response process, and the transport layer protocol comprises:
performing calculation by using a preset hash algorithm based on the protocol port of the request client, the Internet protocol address of the request client, the protocol port of the service response process, the Internet protocol address of the service response process, and the transport layer protocol, and using a calculated hash value as the target client identification information corresponding to the request client.

18. The service response method according to claim 15, wherein the determining a target socket corresponding to the service request packet based on the target client identification information and a pre-established service data file comprises:
in response to having not found the target client identification information or a socket of a service response process corresponding to the target client identification information based on the pre-established service data file, determining the target socket corresponding to the service request packet based on a preset socket option of at least one socket for detecting the preset service port.

19. The service response method according to claim 18, wherein the preset socket option comprises a process flag, and the process flag is used to reflect a correspondence between a socket and a service response process; and
the determining the target socket corresponding to the service request packet based on a preset socket option of at least one socket for detecting the preset service port comprises:
determining the target socket corresponding to the service request packet based on a process flag of the at least one socket for detecting the preset service port.

20. The service response method according to claim 19, wherein the service response process comprises an old service response process for connecting to a service resource before a service version update and a new service response process for connecting to a service resource after the service version update; and
the determining the target socket corresponding to the service request packet based on a process flag of the at least one socket for detecting the preset service port comprises:
determining, based on the process flag of the at least one socket for detecting the preset service port, a socket corresponding to the new service response process as a candidate socket; and
determining the target socket corresponding to the service request packet based on the candidate socket.

21. The service response method according to claim 20, further comprising:
in response to receiving an update instruction for updating a service version of a service resource, creating a child process for connecting to an updated service resource with a service response process currently connected to the service resource as a parent process, and using the parent process as an old service response process, and the child process as a new service response process.

22. The service response method according to claim 21, further comprising:
adding a preset socket option to at least one socket corresponding to the old service response process and used to detect the preset service port, so as to distinguish at least one of the following: a correspondence between the at least one socket and each of the old service response process and the new service response process; and a correspondence between the at least one socket and a packet type of the service request packet.

23. The service response method according to claim 18, wherein the preset socket option further comprises a protocol flag, and the protocol flag is used to reflect a correspondence between a socket and a packet type of the service request packet; and
the determining the target socket corresponding to the service request packet based on a preset socket option of at least one socket for detecting the preset service port comprises:
determining a socket corresponding to the packet type corresponding to the service request packet as a candidate socket based on the protocol flag of the at least one socket for detecting the preset service port; and
determining the target socket corresponding to the service request packet based on the candidate socket.

24. The service response method according to claim 18, wherein after the sending the service request packet to a target service response process through the target socket, the method further comprises:
storing the target client identification information corresponding to the request client and the target socket in correspondence in the service data file.

25. The service response method according to claim 18, further comprising:
in response to finding a socket of a service response process corresponding to the target client identification information based on the pre-established service data file, using the found socket of the service response process corresponding to the target client identification information as the target socket corresponding to the service request packet.

26. An electronic device, comprising:
at least one processor; and
a storage apparatus configured to store at least one program, wherein
the at least one program, when executed by the at least one processor, causes the at least one processor to:
in response to detecting, using a socket detection mechanism, a service request packet initiated by a request client through a preset service port, determine target client identification information corresponding to the request client based on the service request packet;
determine a target socket corresponding to the service request packet based on the target client identification information and a pre-established service data file, wherein client identification information of a connected client having connected to a service response process and a socket of the service response process connected to the connected client are stored in correspondence in the service data file; and
send the service request packet to a target service response process through the target socket.

27. The electronic device according to claim 26, wherein the service request packet carries a protocol port of a request client, an Internet protocol address of the request client, a protocol port of a service response process, an Internet protocol address of the service response process, and a transport layer protocol; and
wherein the at least one processor is caused to determine target client identification information corresponding to the request client based on the service request packet by:
generating the target client identification information corresponding to the request client based on the protocol port of the request client, the Internet protocol address of the request client, the protocol port of the service response process, the Internet protocol address of the service response process, and the transport layer protocol.

28. The electronic device according to claim 27, wherein the at least one processor is caused to generate the target client identification information by:
performing calculation by using a preset hash algorithm based on the protocol port of the request client, the Internet protocol address of the request client, the protocol port of the service response process, the Internet protocol address of the service response process, and the transport layer protocol, and using a calculated hash value as the target client identification information corresponding to the request client.

29. The electronic device according to claim 26, wherein the at least one processor is caused to the determine a target socket corresponding to the service request packet based on the target client identification information and a pre-established service data file by:
in response to having not found the target client identification information or a socket of a service response process corresponding to the target client identification information based on the pre-established service data file, determining the target socket corresponding to the service request packet based on a preset socket option of at least one socket for detecting the preset service port.

30. The electronic device according to claim 29, wherein the preset socket option comprises a process flag, and the process flag is used to reflect a correspondence between a socket and a service response process; and
wherein the at least one processor is caused to determine the target socket corresponding to the service request packet based on a preset socket option of at least one socket for detecting the preset service port by:
determining the target socket corresponding to the service request packet based on a process flag of the at least one socket for detecting the preset service port.

31. The electronic device according to claim 29, wherein the preset socket option further comprises a protocol flag, and the protocol flag is used to reflect a correspondence between a socket and a packet type of the service request packet; and
wherein the at least one processor is caused to determine the target socket corresponding to the service request packet based on a preset socket option of at least one socket for detecting the preset service port comprises:
determining a socket corresponding to the packet type corresponding to the service request packet as a candidate socket based on the protocol flag of the at least one socket for detecting the preset service port; and
determining the target socket corresponding to the service request packet based on the candidate socket.

32. The electronic device according to claim 29, wherein the at least one processor is further caused to:
store the target client identification information corresponding to the request client and the target socket in correspondence in the service data file.

33. The electronic device according to claim 29, wherein the at least one processor is further caused to:
in response to finding a socket of a service response process corresponding to the target client identification information based on the pre-established service data file, use the found socket of the service response process corresponding to the target client identification information as the target socket corresponding to the service request packet.

34. A storage medium comprising computer executable instructions, wherein the computer executable instructions, when executed by a computer processor, are configured to:
in response to detecting, using a socket detection mechanism, a service request packet initiated by a request client through a preset service port, determine target client identification information corresponding to the request client based on the service request packet;
determine a target socket corresponding to the service request packet based on the target client identification information and a pre-established service data file, wherein client identification information of a connected client having connected to a service response process and a socket of the service response process connected to the connected client are stored in correspondence in the service data file; and
send the service request packet to a target service response process through the target socket.
